(19) United States
(12) Patent Application Publication
(10) Pub. No.: US 2012/0206308 A1
(43) Pub. Date: Aug. 16, 2012

(54) ANTENNA APPARATUS AND DUAL-MODE INTELLIGENT TERMINAL

(75) Inventors: Bin Lei, Shenzhen (CN); Chenfei ZHAO, Shenzhen (CN)

(73) Assignee: ZTE Corporation, Shenzhen (CN)

(21) Appl. No.: 13/453,494

(22) Filed: Apr. 23, 2012

(30) Foreign Application Priority Data
May 4, 2010 (CN) 201010162934.7

(51) Int. Cl. H01Q 21/28

(52) U.S. Cl. 343/725

(57) ABSTRACT

Embodiments include an antenna apparatus having a CELL/GPS antenna, located at a short-side of a mainboard of a dual-mode intelligent terminal and configured to receive or transmit EV-DO signals, to receive GPS signals, and to transmit received signals to a CELL/GPS dual-frequency device. The CELL/GPS dual-frequency device is configured to transmit the received EV-DO and GPS signals to an EV-DO module and a GPS module, respectively. A GSM antenna, located at the other short-side of the mainboard of the dual-mode intelligent terminal, is connected with a GSM module, and configured to receive or transmit GSM signals. Embodiments further include a WiFi/BT antenna, located at a long-side of the mainboard of the dual-mode intelligent terminal, connected with a WiFi module and a BT module, and configured to receive or transmit WiFi signals or BT signals. The disclosure also discloses a dual-mode intelligent terminal. Such embodiments can avoid interference among antennae.

### RELATED APPLICATIONS

This application is a continuation under 35 U.S.C. 111(a) of International Application No. PCT/CN2010/076160, filed Aug. 19, 2010 and published as WO 2011/137612 A1 on Nov. 10, 2011, which claims benefit of priority under 35 U.S.C. Section 119 to Chinese Application No. 201010162934 filed on May 4, 2010; which applications and publication are incorporated herein by reference in their entirety.

### TECHNICAL FIELD

The disclosure relates to the field of Code Division Multiple Access (CDMA) 2000 1x Evolution-Data Optimized (EV-DO) and Global System for Mobile Communications (GSM) dual-mode terminals, particularly to an antenna apparatus and a dual-mode intelligent terminal.

### BACKGROUND INFORMATION

The 3rd Generation of Mobile Communication Technology (3G) is a cellular mobile communication technology which supports high-speed data transmission. Besides providing a voice call function, a mobile terminal which adopts the 3G technology also provides a bandwidth wireless data communication function. At present, the 3rd Generation Partnership Project (3GPP) and the 3GPP2 admit three sets of 3G technical standards respectively as follows: European Wideband Code Division Multiple Access (WCDMA), American CDMA200 1x EV-DO and Chinese Time Division-Synchronous Code Division Multiple Access (TD-SCDMA).

Along with the popularization of the 3G, a dual-mode mobile terminal aiming at the 3G is gradually developed and applied. The dual-mode mobile terminal mentioned here is generally a dual-mode mobile terminal having both one system of the 3G and a GSM system, for example, a WCDMA and GSM dual-mode mobile terminal. Following the rapid development of the CDMA2000 1x EV-DO, a new demand is required for a CDMA2000 1x EV-DO system and GSM dual-mode mobile terminal. As the key point of the 3G application is the wideband wireless data communication, a mobile terminal should have a capability of wirelessly accessing to the Internet, such as via Wireless Fidelity (WiFi). In addition, the mobile terminal, in particular, an intelligent terminal is generally required to have Global Position System (GPS) functions and a Bluetooth® (BT) interface to guarantee convenience of the wireless transmission.

As the dual-mode intelligent terminal needs to integrate numerous wireless communication units, and each wireless communication unit is required to have an antenna with corresponding frequency band, how to place these antennae in narrow space of the dual-mode intelligent terminal and how to reduce mutual interference among the antennae of the communication units become the first and foremost problems to be settled. In existing technologies, taking a WCDMA and GSM dual-mode intelligent terminal as an example, the way that the GSM and WCDMA share the antenna is generally adopted; and as far as a CDMA2000 1x EV-DO and GSM dual-mode mobile terminal is considered, there is no processing chip for the CDMA2000 1x EV-DO and the GSM to share the antenna; for such brand-new dual-mode intelligent terminals, there is no solution of corresponding antenna structure in a current market.

### SUMMARY

On that account, some embodiments herein provide an antenna apparatus and a dual-mode intelligent terminal adaptable to the field of the dual-mode intelligent terminal and capable of reducing interference among antennae while the antennae are arranged rationally.

For example, some embodiments include a CELL/Global Positioning System (GPS) antenna, located at a short-side of a mainboard of a dual-mode intelligent terminal and configured to receive or transmit Evolution-Data Optimized (EV-DO) signals, to receive GPS signals, and to transmit the received signals to a CELL/GPS dual-frequency device. Further, the CELL/GPS dual-frequency device, may be configured to transmit the received EV-DO and GPS signals to an EV-DO module and a GPS module respectively. Additionally, a Global System for Mobile Communications (GSM) antenna, located at the other short-side of the mainboard of the dual-mode intelligent terminal, maybe connected with a GSM module, and configured to receive or transmit GSM signals. Additionally, a Wireless Fidelity (WiFi)/BlueTooth® (BT) antenna, maybe located at a long-side of the mainboard of the dual-mode intelligent terminal, connected with a WiFi module and a BT module, and configured to receive or transmit WiFi signals or BT signals.

In such embodiments, the CELL/GPS dual-frequency device may be specifically configured to receive the mixed EV-DO and GPS signals transmitted from the CELL/GPS antenna, and may be internally provided with two filters. One such filter may filter away the EV-DO signals from the mixed signals and transmit the obtained GPS signals to the GPS module, and the other filter may filter away the GPS signals from the mixed signals and transmit the obtained EV-DO signals to the EV-DO module.

Further, the distance between the CELL/GPS antenna and the GSM antenna may be required to be more than 105 mm and the WiFi/BT antenna may be located at a middle position of the long-side of the mainboard of the dual-mode intelligent terminal so as to have the same distance to both the CELL/GPS antenna and the GSM antenna.

Some embodiments also comprise a dual-mode intelligent terminal, which includes a display unit, an input unit and a mainboard as well as an antenna apparatus. The antenna apparatus may specifically include a CELL/Global Positioning System (GPS) antenna, located at a short-side of a mainboard of the dual-mode intelligent terminal and configured to receive or transmit EV-DO signals, to receive GPS signals, and to transmit the received signals to a CELL/GPS dual-frequency device. The antenna apparatus may further include the CELL/GPS dual-frequency device, configured to transmit the received EV-DO and GPS signals to an EV-DO module and a GPS module of the mainboard respectively. The antenna apparatus may additionally include a GSM antenna, located at the other short-side of the mainboard of the dual-mode intelligent terminal, connected with a GSM module, and configured to receive or transmit GSM signals. Additionally, a WiFi/BT antenna may be included that is located at a long-side of the mainboard of the dual-mode intelligent terminal, connected with a WiFi module and a BT module, and configured to receive or transmit WiFi signals or BT signals.

By adopting the antenna apparatus of the dual-mode intelligent terminal in which the CELL/GPS antenna, the GSM antenna, and the WiFi/BT antenna are respectively placed at different locations of the dual-mode intelligent terminal and the distance among the antennae are as great as possible, the interference among the antennae is reduced while the antennae are arranged rationally.

### BRIEF DESCRIPTION OF THE DRAWINGS

FIG. 1 is a schematic diagram of components for realizing an antenna apparatus, according to an example embodiment.

FIG. 2 is a schematic diagram of components for realizing a dual-mode intelligent terminal, according to an example embodiment.

### DETAILED DESCRIPTION

As set forth herein, various embodiments provide antennae within a mobile device (wireless telephone, smartphone, tablet, and the like) that are able to receive and transmit various wireless device signals. Generally, an antenna apparatus may include a first antenna that is shared to receive and transmit CELL, that is, CDMA2000 1x EV-DO signals, and to receive GPS signals. The antenna apparatus may further include an antenna that is shared to receive and transmit WiFi signals and BT signals, as well as a third antenna that is used to receive and transmit GSM signals. The first, second, and third antennae are arranged, in such embodiments, a suitable distance to avoid interference among the antennae while implementing the placement of the antennae. The disclosure is further described below with reference to the drawings and embodiments in detail.

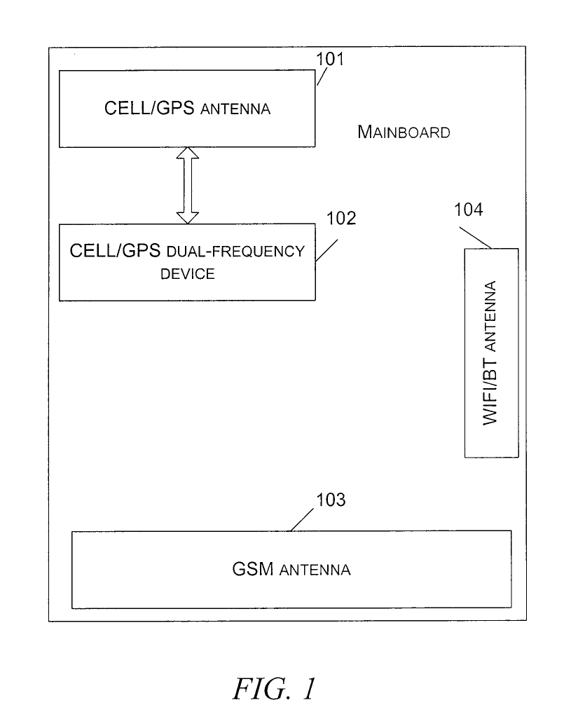

FIG. 1 is a schematic diagram of components for realizing an antenna apparatus, according to an example embodiment. As shown in FIG. 1, an antenna apparatus includes a CELL/GPS antenna 101, a CELL/GPS dual-frequency device 102, a GSM antenna 103, and a WiFi/BT antenna 104, wherein the distance among the antennae is controlled to avoid signal interference. The CELL/GPS antenna 101 is located at a short-side of a mainboard of a dual-mode intelligent terminal, connected with the CELL/GPS dual-frequency device 102, and configured to receive or transmit EV-DO signals and to receive GPS signals. In some embodiments, the EV-DO signals are at the frequency band of 850 MHz, and the GPS signals are at the frequency band of 1575.42 MHz.

In some embodiments, the CELL/GPS dual-frequency device 102 is connected with the CELL/GPS antenna 101, an EV-DO module, and a GPS module, and configured to respectively transmit the EV-DO signals and the GPS signals transmitted from the CELL/GPS antenna 101 to the EV-DO module and the GPS module. The EV-DO module is typically located on the mainboard of the dual-mode intelligent terminal and configured to receive, transmit, and process the EV-DO signals and to provide an EVDO communication function. The GPS module is also typically located on the mainboard of the dual-mode intelligent terminal and configured to receive the GPS signals and provide a GPS function.

The GSM antenna 103 is typically located at the other short-side of the mainboard of the dual-mode intelligent terminal, connected with a GSM module, and configured to receive and transmit GSM signals. The GSM signals may comprise four frequency bands. The four frequency bands may include 850 MHz, 900 MHz, 1800 MHz, and 1900 MHz. The GSM module is typically located on the mainboard of the dual-mode intelligent terminal and configured to receive, transmit, and process the GSM signals and to provide a GSM communication function.

The WiFi/BT antenna 104 may be located at a left long-side or right long-side of the mainboard of the dual-mode intelligent terminal, connected with a WiFi/BT module, and configured to receive and transmit WiFi signals or BT signals. The WiFi or BT signals are at the frequency band of 2.4 GHz. The WiFi/BT module is located at the mainboard of the dual-mode intelligent terminal and configured to receive, transmit, and process the WiFi/BT signals and to provide WiFi and BT functions. The functions of receiving, transmitting, and processing the WiFi/BT signals may include the WiFi/BT module receiving signals, determining that the signals are the WiFi signals or the BT signals according to a signal protocol, starting the corresponding module through a switch thereof according to different signals, timely starting or stopping the WiFi module and the BT module to facilitate the WiFi module, and the BT module working in time division when the signals are mixed signals.

The CELL/GPS dual-frequency device 102 may be specifically configured to receive the mixed EV-DO and GPS signals transmitted from the CELL/GPS antenna 101. The CELL/GPS dual-frequency device 102 is internally provided with two filters. The first filter filters away the EV-DO signals from the mixed signals and transmits the obtained GPS signals to the GPS module. The second filter filters away the GPS signals from the mixed signals and transmits the obtained EV-DO signals to the EV-DO module.

Furthermore, the distance between the CELL/GPS antenna 101 and the GSM antenna 103 more than 105 mm. Further, the WiFi/BT antenna 104 should be located at a middle position of the side part of the mainboard of the dual-mode intelligent terminal so as to have the distance as same as possible to both the CELL/GPS antenna 101 and the GSM antenna 103.

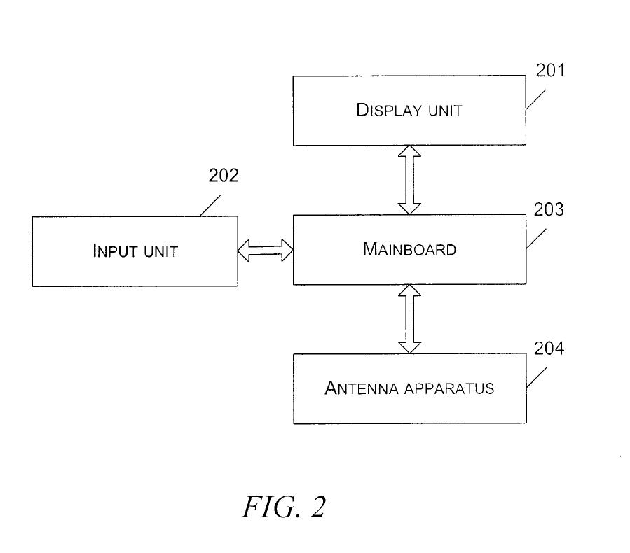

FIG. 2 is a schematic diagram of components for realizing a dual-mode intelligent terminal, according to an example embodiment.

Some embodiments include a dual-mode intelligent terminal. A dual-mode intelligent terminal includes a display unit 201, an input unit 202, a mainboard 203, and an antenna apparatus 204.

The display unit 201 is connected with the mainboard 203 and configured to display an operation result of the dual-mode intelligent terminal.

The input unit 202 is connected with the mainboard 203 and configured to provide an operation interface for a user.

The mainboard 203 is configured to provide a carrier for hardware realizing operation of the dual-mode intelligent terminal.

The antenna apparatus 204 is connected with the mainboard 203, configured to receive and transmit wireless signals of the dual-mode intelligent terminal, and comprises a CELL/GPS antenna, a GSM antenna, a WiFi/BT antenna and a CELL/GPS dual-frequency device.

The CELL/GPS antenna is located at a short-side of the mainboard of the dual-mode intelligent terminal, connected with the CELL/GPS dual-frequency device, and configured to receive and transmit EV-DO signals and to receive GPS signals. The EV-DO signals are typically at the frequency band of 850 MHz, and the GPS signals are at the frequency band of 1575.42 MHz.

The CELL/GPS dual-frequency device is connected with the CELL/GPS antenna, an EV-DO module and a GPS module, and configured to respectively transmit the EV-DO signals and the GPS signals transmitted from the CELL/GPS antenna to the EV-DO module and the GPS module. The EV-DO module is located on the mainboard of the dual-mode intelligent terminal and configured to receive, transmit and process the EV-DO signals and to provide an EVDO communication function. The GPS module is located on the mainboard of the dual-mode intelligent terminal and configured to receive the GPS signals and provide a GPS function.

The GSM antenna, in some embodiments, is located at the other short-side of the mainboard of the dual-mode intelligent terminal, connected with a GSM module, and configured to receive and transmit GSM signals. The GSM signals comprise four frequency bands. The four frequency bands, in some embodiments, are 850 MHz, 900 MHz, 1800 MHz, and 1900 MHz. The GSM module is typically located on the mainboard of the dual-mode intelligent terminal and configured to receive, transmit, and process the GSM signals and to provide a GSM communication function.

The WiFi/BT antenna is typically located at a left, long-side or right, long-side of the mainboard of the dual-mode intelligent terminal. connected with a WiFi/BT module, and configured to receive and transmit WiFi signals or BT signals. The WiFi or BT signals are typically at the frequency band of 2.4 GHz. The WiFi/BT module is typically located at the mainboard of the dual-mode intelligent terminal, and configured to receive, transmit, and process the WiFi/BT signals, and to provide WiFi and BT functions. The functions of receiving, transmitting, and processing the WiFi/BT signals may include the WiFi/BT module receiving signals, determining that the signals are the WiFi signals or the BT signals according to a signal protocol, starting the corresponding module through a switch thereof according to different signals, timely starting or stopping the WiFi module and the BT module to facilitate the WiFi module and the BT module to work in time division when the signals are the mixed signals.

In some embodiments, the CELL/GPS dual-frequency device is specifically configured to receive the mixed EV-DO and GPS signals transmitted from the CELL/GPS antenna, and is internally provided with two filters. A first filter filters away the EV-DO signals from the mixed signals and transmits the obtained GPS signals to the GPS module. The second filter filters away the GPS signals from the mixed signals and transmits the obtained EV-DO signals to the EV-DO module.

Furthermore, the distance between the CELL/GPS antenna and the GSM antenna is more than 105 mm. The WiFi/BT antenna is located at a middle position of the side part of the mainboard of the dual-mode intelligent tenninal so as to have the distance as same as possible to both the CELL/GPS antenna and the GSM antenna.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. An antenna apparatus, comprising:
a CELL/Global Positioning System (GPS) antenna, located at a short-side of a mainboard of a dual-mode intelligent terminal and configured to receive or transmit Evolution-Data Optimized (EV-DO) signals, to receive GPS signals, and to transmit the received signals to a CELL/GPS dual-frequency device;
the CELL/GPS dual-frequency device, configured to transmit the received EV-DO and GPS signals to an EV-DO module and a GPS module respectively;
a Global System for Mobile Communications (GSM) antenna, located at the other short-side of the mainboard of the dual-mode intelligent terminal, connected with a GSM module, and configured to receive or transmit GSM signals; and
a Wireless Fidelity (WiFi)/BlueTooth® (BT) antenna, located at a long-side of the mainboard of the dual-mode intelligent terminal, connected with a WiFi module and a BT module, and configured to receive or transmit WiFi signals or BT signals.

2. The apparatus according to claim 1, wherein the CELL/GPS dual-frequency device is specifically configured to receive the mixed EV-DO and GPS signals transmitted from the CELL/GPS antenna, and is internally provided with two filters;
wherein one filter filters away the EV-DO signals from the mixed signals and transmits the obtained GPS signals to the GPS module, and the other filter filters away the GPS signals from the mixed signals and transmits the obtained EV-DO signals to the EV-DO module.

3. The apparatus according to claim 2, wherein the distance between the CELL/GPS antenna and the GSM antenna is required to be more than 105 mm; and
the WiFi/BT antenna is located at a middle position of the long-side of the mainboard of the dual-mode intelligent terminal so as to have the same distance to both the CELL/GPS antenna and the GSM antenna.

4. A dual-mode intelligent terminal, comprising: a display unit, an input unit and a mainboard, further comprising an antenna apparatus; wherein the antenna apparatus comprises:
a CELL/Global Positioning System (GPS) antenna, located at a short-side of a mainboard of the dual-mode intelligent terminal and configured to receive or transmit EV-DO signals, to receive GPS signals, and to transmit the received signals to a CELL/GPS dual-frequency device;
the CELL/GPS dual-frequency device, configured to transmit the received EV-DO and GPS signals to an EV-DO module and a GPS module of the mainboard respectively;
a GSM antenna, located at the other short-side of the mainboard of the dual-mode intelligent terminal, connected with a GSM module, and configured to receive or transmit GSM signals; and
a WiFi/BT antenna, located at a long-side of the mainboard of the dual-mode intelligent terminal, connected with a WiFi module and a BT module, and configured to receive or transmit WiFi signals or BT signals.

5. The dual-mode intelligent terminal according to claim 4, wherein the CELL/GSP dual-frequency device is specifically configured to receive the mixed EV-DO and GPS signals transmitted from the CELL/GPS antenna, and is internally provided with two filters; wherein one filter filters away the EV-DO signals from the mixed signals and transmits the obtained GPS signals to the GPS module, and the other filter filters away the GPS signals from the mixed signals and transmits the obtained EV-DO signals to the EV-DO module.

6. The dual-mode intelligent terminal according to claim 5, wherein the distance between the CELL/GPS antenna and the GSM antenna is required to be more than 105 mm; and
the WiFi/BT antenna is located at a middle position of the long-side of the mainboard of the dual-mode intelligent terminal so as to have the same distance to both the CELL/GPS antenna and the GSM antenna.
